(19) United States
(12) Patent Application Publication
(10) Pub. No.: US 2003/0086428 A1
(43) Pub. Date: May 8, 2003

(54) Switching unit for a packet-transmitting network, to switch the packets of a connection at one input of said connections' ports to at least one of its outputs

(76) Inventors: Jean-Paul Quinquis, Perros-Guirec (FR); Jean-Yves Cochennec, Trebeurden (FR); Olivier Roussel, Perros-Guirec (FR); Thierry Houdoin, Pleumeur Bodou (FR)

Correspondence Address: LOWE HAUPTMAN GILMAN & BERNER, LLP, Suite 310, 1700 Diagonal Road, Alexandria, VA, 22314, US

(21) Appl. No.: 10/166,712

(22) Filed: Jun. 12, 2002

(30) Foreign Application Priority Data
Jun. 12, 2001 (FR) 01 07766

(51) Int. Cl. H04L 12/28

(52) U.S. Cl. 370/395.1

(57) ABSTRACT

A packet network switching unit switches “upper layer packets” at an input port thereof toward a selected output port. Lower layer packets transport the “upper layer packets.” A receiving termination module of the unit (1) retrieves upper layers from lower layer packets at its input, (2) inserts each retrieved upper layer into a lower layer packet, (“intermediate packet”) and (3) delivers the intermediate packet. A transmitting termination module retrieves the upper layer packet from the intermediate packet, optionally inserts it with other packets into a lower layer packet and delivers the lower layer packets. A switch routes lower layer packets to an input of a receiving termination module that routes (1) intermediate packets transmitted by the receiving module toward one of its output ports, connected to a transmitting termination module input and (2) packets transmitted from the lower layer through each transmitting module toward the unit desired output port.

The present invention relates to a switching unit of a packet transmitting network to switch packets of a connection at one input of said connection's ports to at least one output of its ports, said packets, termed “upper layer packets,” being transported by lower layer packets.

In the present description and in the attached claims, the term “layer” denotes protocol layers illustratively defined in the OSI or any other model and which each relate to a set of operations implemented on upper or lower layer data units.

The present invention refers to two layers of which one is higher than the other because contributing a set of additional functions such as routing. In a particular application of the present invention, the upper layer packets are specified in the AAL2 protocol whereas the lower layers are ATM cells. It is understood however that the present invention is not limited to this particular application.

The AAL2 protocol is described as follows: The transportation of information under the protocol AAL2 (ITU Recommendations I363.2, I366.1 and I366.2) and associated implementation (ITU Recommendation Q.2630.2) are recommended or considered in various communication networks of which the presently best known is the 3^{rd} generation access network for mobiles dubbed UTRAN (UMTS Terrestrial Radio Access Network). Using this AAL2 protocol on an ATM type cell access network was definitively adopted by the 3GPP standards organization for the 1999 UTRAN version (R99) which presently is called R3. Accordingly the present invention is particularly applicable to the architectures of the RNC mobiles network controller and so-called node B base stations of an UTRAN access network, and also to concentrators/switches carrying out AAL2 switching.

Other fields of application may be considered, illustratively voice transport on ADSL connecting private switches PABX via an ATM transport network using the “trunking” defined in the SSCS sub-layer defined in ITU Recommendation I366.2.

A brief description is given below of the principles determining the so-called AAL2 transport protocol described in the above cited three ITU Recommendations. This transport protocol was defined to circumvent the problem raised by the assembly time of an ATM cell, said time being critical at low bit rates: At 16 kbits/s and assuming entirely filling the ATM cell, this assembly time is 24 ms. The solution that was adopted multiplexes the flows of several communications in one ATM channel by structuring the informations into one packet hereafter called AAL2 packets. This transport mode constitutes the low part of the so-called CPS sublayer (Common Part Sublayer). The mandatory adaptation functions are situated above the CPS sublayer in so-called SSCS sublayers (Service Specific Convergence Sublayers). The first of these sublayers, namely the segmenting SSCS sublayer, is described in ITU Recommendation I366.1 and is used to transport data units containing a large number of octets. The second, real-time trunking SSCS sublayer is described in ITU Recommendation I366.2.

One sequence of packets AAL2 is guaranteed in each channel AAL2, but the service provided by the CPS sublayer is unwarranted, that is, missing packets (for instance due to losing ATM cells transporting them) are not replaced by retransmitting at this level.

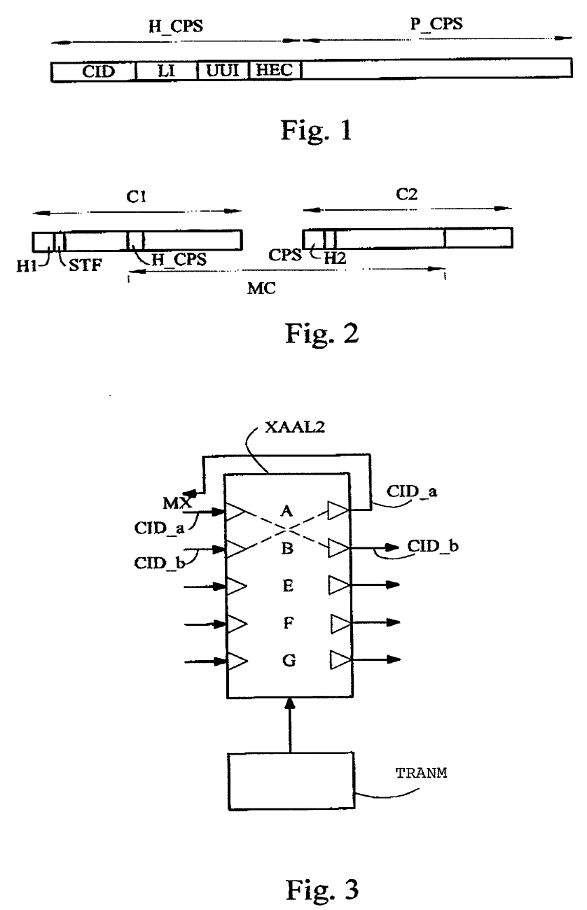

FIG. 1 shows the format of the AAL2 packets of the CPS layer of the AAL2 protocol such as specified in ITU recommendation I363.2. AAL2 packets are fitted with a three-octet header H_CPS and comprise a payload P_CPS of variable length containing the user information. The default length is limited to 45 octets. As shown in FIG. 1, the header H_CPS contains the following fields:

a connection identification field CID of 8 bits allowing identifying the AAL2 connection,

a 6-bit field coding the length LI of the packet payload in a manner that LI+1 be equal to the number of octets,

a 5-bit user-to-user information field UUI,

a 5-bit header error protection field HEC.

The lengths of the AAL2 packets are arbitrary. In general they will not be framed in the ATM cells which transport them. Cell filling is assured by the overlapping technique. Illustratively a packet beginning at the end of a cell n may spill over into the next cell n+1. Illustratively FIG. 2 shows two ATM cells C1 and C2 containing an AAL2 packet MC. The first octet following the header H1 of cell C1 is called the “start field” (STF) and essentially contains a 6-bit pointer also called “offset field” (OSF)coding the number of octets separating this field from the next CPS packet, in this instance the MC packet, or, in the general case, from the next empty field. A zero value denotes that the AAL2 packet immediately follows the STF octet. The maximum value borne by the pointer OSF is 47 denoting that the ATM cell is devoid of any datum. Managing this pointer allows transporting securely an arbitrary number of packets in the consecutive ATM cells of one virtual circuit. Accordingly the hookup efficiency measured as the filling rate will be optimal. A sequence number (SN) bit and a parity bit also are part of the STF octet.

The various equipment constituting a telecommunications network manage terminations both with respect to receiving and transmitting. A termination is bidirectional and therefore includes a receiver termination module and a transmitter termination module. This is the case for instance in a network such as a mobile access network like the above described UTRAN, the RNC network controller or at each so-called NODE B base station. The same feature applies to the switch XAAL2 of FIG. 3 of which each port A, B, E, F, G comprises a receiving termination module (inward-apex triangle) and a transmitting termination model (outward-apex triangle).

In an AAL2-protocol supporting network, a termination AAL2 constitutes the end of an ATM multiplexer (such as MX illustratively shown in FIG. 3) wherein one or several virtual circuits VC may exhibit different parameters of traffic and service quality called ATC.

In general, a receiving termination module retrieves AAL2 packets from the ATM cells. Such a module hereafter shall be termed “in-AAL2.” More specifically, the main operations performed by such a receiving module are:

decoding the start-field (STF) of the AAL2 packets contained in the incoming ATM cells and determining the pointers, controlling sequencing and managing errors,

decoding the pointers-pointed headers of the AAL2 packets for the purpose of determining the CID connection identification, the length LI, the UUI field and the error code HEC,

retrieval and assembly at the AAL2 level or at the level of a radio frame.

The data formats at the output of the receiving termination module depend of the processing the latter carries out. This processing may relate the payload of the packets AAL2, for instance managing the MAC/RLC layers as regards an RNC network controller. The processing may be at the level of the SSCS sublayers. Another instance is packet switching and, in that case, the pertinent processing is in the language translation of the particular ATM cell headers and AAL2 packets.

In turn a transmitting termination module both inserts and multiplexes packets in the payload of the ATM cells. Such a module is termed “out-AAL2” in the description herebelow. The performed operations are as follows:

optionally processing AAL2 packets corresponding to the SSCS sublayers,

coding the start field (STF) octet, that is, determining the pointer and controlling sequencing the ATM cells,

coding the headers of the AAL2 packets: determining the connection identifier CID, the length LI and the error code HEC

managing a Timer-CU of which purpose is to assure an optimal filling rate in the light of the delay constraints,

inserting and multiplexing AAL2 packets in ATM cells, and

transmitting ATM cells.

The format of the input data depends on the internal interface.

In order to commute AAL2 packets, a virtual-circuit switch is used that, as regards the user, implements on one hand the termination operations of the AAL2/CPS layers such as those discussed above and on the other hand the translation operations of the virtual circuit identifiers and of connections, and the routing according to the protocol model which shall now be described. Be it borne in mind that such a switch only recognizes the CPS sublayer of the AAL2 layer and therefore is transparent to the payloads of the AAL2 packets.

The AAL2 connections are determined by a signaling protocol (generally according to the ITU Recommendation Q2630.2) which assures call admission control (CAC) and allows traffic management. The connection parameters are stored in a Translation Memory (TRANM) associated with the switch (FIG. 3).

An AAL2 connection consists of two connection halves, one ascending and one descending. The flows on each connection half are not necessarily identical. Very schematically, switching the AAL2 packets consists in setting up a link between two bi-directional half connections AAL2.

FIG. 3 shows that the particular half connection of which the termination is the physical port A, is identified by the CID_a identifier and that the half connection of which the termination is the port B is identified by the CID_b identifier. One may observe that the switch XAAL2 sets up a link between the half connection CID_a at the input side of the receiving module at port A and the half connection CID_b which is outgoing from the transmitting module at the port B. Similarly said switch XAAL2 sets up a link between the half connection CID_b at the input side of the receiving module at port B and the half connection CID_a is outgoing from the transmitting module of the port A.

The routing parameters of the AAL2 connections are stored in the translation memory TRANM allocated to the switch XAAL2. The links in this instance are set up between the left and right side multiplexers.

Such 5-fold port switch may be used as a so-called network control (RNC) in which the ports E, F an G would be connected to links Iub, the port A would be connected to the interface Iu, the port A to an interface Iur.

The table below lists illustrative routing parameters such as are stored in the switch's translation memory TRANM. The features of traffic or priority are omitted from this table. For each connection—both upward and downward—the switch XAAL2 links the ports stated on the left of the table with the corresponding ones on the right side of it, and vice-versa, and it implements the translation, on one hand of the virtual circuit identifiers—in this instance the virtual path identifier VPI and the virtual circuit identifier VCI—and on the other hand the CID connection identifier.

| | PORT | VPI | VCI | CID | PORT | VPI | VCI | CID |
|---|---|---|---|---|---|---|---|---|
| C × 1 | A | 0 | 100 | 10 | E | 0 | 100 | 15 |
| C × 2 | A | 0 | 100 | 20 | G | 0 | 200 | 30 |
| C × 3 | A | 0 | 110 | 10 | F | 0 | 100 | 20 |
| C × 4 | A | 0 | 110 | 30 | E | 0 | 100 | 30 |
| C × 5 | B | 0 | 100 | 15 | E | 0 | 100 | 30 |
| C × 6 | B | 0 | 100 | 20 | F | 0 | 150 | 25 |

Illustratively considering the cx2 link, the operation of the switch XAAL2 shown in the table is as follows: The packets AAL2 transported by the virtual circuit VC (0, 100) that were identified by the connection identifier CID=20 and received at the port A are routed toward the port G in the virtual circuit VC (0, 200) with the connection identifier CID=30. Vice-versa, the packets transported in the virtual circuit VC (0, 200) that were identified by the identifier CID=30 and received at the port G are routed toward the port A in the virtual circuit VC (0, 100) with the identifier CID=20.

The other examples of this table may be easily interpreted by extrapolating from the above illustration.

For instance it may be inferred that this processing on one hand implements the routing from one to another port of this switch and on the other hand the translation of the identifiers of the virtual circuits VPI, VCI of the ATM cells transporting said AAL2 packets and of the connection identifiers CID of the very AAL2 packets. Accordingly the switching of the AAL2 packets may be operationally considered being in three stages:

1) receiving ATM cells carrying AAL2 packets (packets of the CPS AAL2 sublayer) and retrieving from latter said ATM cells,

2) translating the virtual circuit identifiers of said ATM cells and the connection identifiers of said retrieved AAL2 packets, then routing within the switch said retried AAL2 packets toward the desired output port of the switch, and lastly

3) inserting the CPS AAL2 packets into ATM cells which then are transmitted.

The objective of the present invention is to create a switch architecture allowing switching AAL2 packets in the above described manner. More specifically the invention relates to carrying out such switching of AAL2 packets using a switch already originally designed to switch ATM cells.

Generally speaking the goal of the present invention is a switching unit for a transmission network and used two switch packets which are present at one input of a connection's ports toward at least one desired output to the connection's ports, said packets, the so-called upper layer packets, being transported by lower layer packets.

A switching unit of a packet transmitting network of the present invention is characterized by comprising:

at least one receiving termination module designed to retrieve—from the lower level packets present at its input—the upper layer packets that they contain, in order to insert each upper layer packet so retrieved into a unique lower packet layer, called the “intermediary packet”, and to deliver said intermediary packet,

at least one transmitting termination module to retrieve said upper layer packet from said intermediary packet for the purpose of inserting it, optionally together with other packets, into one or several lower layer packets and to deliver said lower layer packets,

a switch to route said lower layer packets which are present at one of its inputs toward the output of one of its ports that is connected to the input of a receiving termination module for the purpose of routing the intermediate packets transmitted by said or each receiving termination module toward the output of one of its ports that is connected to the input to the input of one transmitting termination module and to route the packets transmitted from the lower layer by said or each transmitting termination module toward the desired output of said port of said unit.

In one advantageous embodiment of the present invention, said switching unit comprises a module designed to process in specific manner upper layer packets, said processing module being designed to receive the intermediate packets transmitted by the receiving termination module for the purpose of processing the upper layer packets contained in said intermediate packets and in order to transmit said intermediary packets into which said upper layer packets thusly processed are inserted. In this instance said switch illustratively is designed to route said lower layer packets at one of its inputs to the output of one of its ports connected to the input of a receiving termination module for the purpose of routing the intermediate packets transmitted by said or each receiving termination module toward the output of one of its ports connected to the input of said processing unit, to route the intermediate packets re-transmitted by said processing unit toward the output of one of its ports connected to the input of a transmitting termination module and to route the lower layer packets transmitted by said or each transmitting termination module toward the desired output of said port of said unit.

In another feature of the present invention, said switch is designed to route those lower layer packets that do not contain upper layer packets directly toward the desired output of said switching unit.

In another feature of the invention, said upper layer packets comprise a header containing a connection identifier, said or each receiving termination module carrying out the translations of connection identifiers required for switching.

In another feature of the invention, said upper layer packets comprise a header containing a connection identifier, said or each transmitting termination module carrying out the translations of connection identifiers required for switching.

In yet another feature of the invention, said lower layer packets comprise a header including a circuit identifier, said or each receiving or transmitting termination module carrying out the connection identifier translations required for switching.

In yet another feature of the invention, said switching unit comprises a signaling unit to process the signaling packets corresponding to the protocol of the upper layer packets and designed to control the identifier translation memories contained in said switch, in said receiving termination module and/or in said transmitting termination module.

Another feature of the invention comprises several receiving termination modules and several transmitting termination modules, said models being dedicated to particular connections and/or virtual circuits.

In still another feature of the present invention, it comprises at least one pair of receiving termination modules and at least one pair of transmitting termination modules, each module of each pair being assigned to a particular rising or descending direction of connection.

The above mentioned features of the invention and more shall be elucidated in the following description of an illustrative embodiment of said invention and in relation to the attached drawings.

FIG. 1 diagrammatically shows the format of a packet from the AAL2/CPS layer,

FIG. 2 diagrammatically shows the insertion of an AAL2 packet into two ATM cells,

FIG. 3 is a summary diagram of an AAL2-packet switching unit,

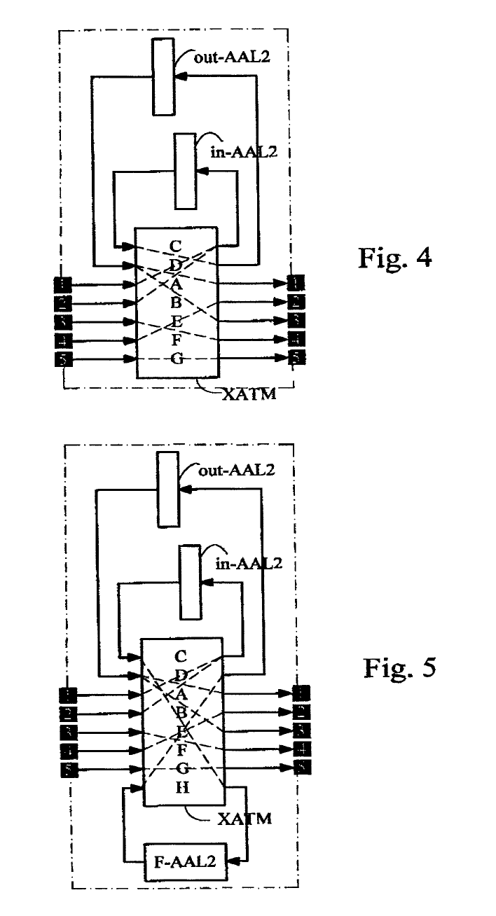

FIG. 4 is a summary diagram of an AAL2-packet switching unit of another and particular embodiment mode of the present invention,

FIG. 5 is a summary diagram of an AAL2-packet switching unit of another particular embodiment of the present invention, and

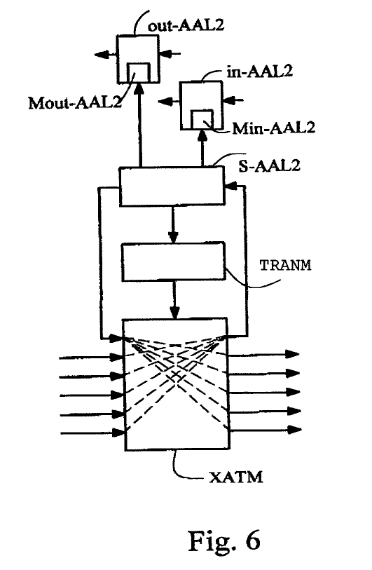

FIG. 6 is a summary diagram of an AAL2-packet switching unit of the particular design already shown above in relation to FIG. 4, but in this instance used for signaling.

The principle of the present invention is to arrange each upper layer packet B previously retrieved from the lower layer packets at the input of a port—into a unique lower layer packet, denoted as “intermediate packet”, to route said intermediate packet depending on the processing to be applied to the corresponding said upper layer packet, next to retrieve each upper layer packet from each intermediate packet, to insert said retrieved upper layer packet into lower layer packets by multiplexing them in the latter, and then routing said lower layer packets toward the desired port's output.

More specifically and as regards a particular application, the lower layer packets are ATM cells whereas the upper layer packets are AAL2 packets. In such an embodiment, the present invention consists in arranging each packet retrieved from one or several packets at the input of a port into a single ATM cell which is denoted “intermediate cell” by means of a receiving termination module (in-AAL2), furthermore by routing said intermediate packet with respect to the processing to be applied to the AAL2 packet it contains, namely in a conventional ATM switch, next retrieving each packet from each intermediate ATM cell, inserting by means of transmitting termination modules (out-AAL2) each AAL2 packet into ATM output cells by multiplexing them in said ATM cells, and then routing said ATM cells toward the desired output port.

FIG. 4 shows a switching unit 10 of the present invention. Said unit essentially consists of a switch XATM of which at least one port (in this case one) is connected by its output to the input of a receiving termination module, namely in-AAL2, and its input is connected to the output of said receiving termination module in-AAL2, and of which at least one other port (in this case one) is connected by its output to the input of a transmitting termination module, out-AAL2 and its input is connected to the output of said out-AAL2 transmitting termination module.

The or each in-AAL2 receiving module carries out standardized receiving operations (in particular receiving and retrieving the AAL2 packets from the ATM cells) and transmitting operations (encapsulating each AAL2 packet into an ATM cell). However the encapsulating procedure is much simplified because only a single AAL2 packet is inserted into the intermediate cell and consequently neither octet management STF nor Timer CU are necessary. Moreover in the intermediary ATM cell, the STF octet is useless because the pointer always is 0. The packet contained in this cell is framed onto the first octet of this cell's payload. Absence of the STF octet allows inserting a 45-octet long packet (maximum length) into a single ATM cell.

The or each out-AAL2 transmission module operates as a receiver (receiving and retrieving the AAL2 packet contained in each intermediate cell, such retrieval being much simplified because of the simplicity of the above encapsulation procedure) and as a transmitter (insertion of the AAL2 packets previous retrieved form the ATM cells according to the above cited AAL2 protocol, and lastly transmission of said ATM cells).

Essentially the XATM switch operates as a router for the ATM cells whether these be intermediate or not and also as a translator of the virtual circuit identifiers of these ATM cells.

The translations of the CID connection identifiers of the AAL2 packets are carried out in the in-AAL2 receiving modules or, advantageously, the out-AAL2 transmission modules.

Be it noted that the translation of the virtual circuit identifiers contained in the headers of the incoming ATM cells also may be carried out by the in-AAL2 modules or, advantageously, by the out-AAL2 modules and by the XATM switch.

Operation is as follows. The ATM cells transporting AAL2 packets and present on at least one of the inputs 1 through 5 are routed onto the output of port C and hence toward the input of the in-AAL2 receiving module. This is the case for ATM flows at the inputs 1 and 2 as indicated by the dashed lines.

As regards the ATM cell flows at the inputs 3, 4 and 5, which do not carry AAL2 packets, they will be respectively routed directly toward the outputs 4, 2 and 5.

In the in-AAL2 receiving module, each AAL2 packet is retrieved from the ATM cell(s) where it was inserted and is encapsulated into a single ATM cell called the “intermediate cell”. Thereupon this intermediate cell is transmitted toward the input of the port C of the XATM switch where it is routed by this switch XATM toward the output of the port D and thereby it will be back at the input of the out-AAL2 transmitting module.

There the packet AAL2 contained in each intermediate cell will be retrieved and then inserted into a flow of ATM cells which shall be moved to the desired output port. In this case and according to the connections to which the applicable AAL2 packets belong, the cell flow toward the port D shall be routed, either toward the output of the port A in order to be on the output 1 of the switching unit or toward the output of the port E in order to be on the output 3 of the switching unit.

To carry out the AAL2 switching operation, the solution offered by the present invention consists in placing an ATM switch between in-AAL2 receiving termination modules and out-AAL2 transmitting termination modules.

In summary, the advantages obtained when compared to an AAL2 switch such as shown in FIG. 3 are the following:

the processing of the operations of retrieval and insertion in the separate transmitting and receiving termination modules does improve performance because the procedures are processed in separate “hardware or software machines”,

additional transmitting and receiving termination models may be added to increase switching power and to improve operational reliability,

the routing operations are carried out in an XATM switch of ATM type that is widely used presently,

by using a conventional ATM switch, all operations designed into such apparatus may be processed, for instance the operations of intermingling virtual pipes VP, of switching virtual circuits VC etc. and of making use of the range of pre-existing physical accesses, optical, electrical, of different rates.

To resolve the problem of overhead between the in-AAL2 receiving termination modules and out-AAL2 transmitting termination models, a number of approaches may be followed: assuring that the binary flow at the output multiplexer be larger than that of the input multiplexer, multiplying the number of output multiplexers.

Be it borne in mind that several in-AAL2 receiving termination modules and several out-AAL2 transmitting termination modules may be configured as servers in the manner of those shown in FIG. 4. Again, each module may terminate one or more AAL2 links. The number of links at the input and at the output of a module may be different. The selected configuration may depend on constraints relating to the AAL2 traffic to be switched.

FIG. 5 shows an embodiment mode of a switching unit of the present invention wherein particular processing is applied to the payload of the AAL2 packets. This particular processing is carried out by a module denoted F-AAL2. This processing illustratively concerns termination functions above the CPS sublayer, for instance managing sublayers of the MAC and RLC radio protocols in an RNC network controller or at the PDU level for processing in the SSCS sublayers.

Be it also noted that a switching unit of the present invention may comprise several processing units of the F-AAL2 type where processing in parallel may be required.

In one embodiment shown in FIG. 5, the XATM switch comprises one more port than does the XATM switch of FIG. 4. The output of this port H is connected to the input of the processing module F-AAL2 whereas its input receives the output form the F-AAL2 module.

The operation of the embodiment of FIG. 5 differs from that shown in FIG. 4 in that the intermediate cell delivered by the in-AAL2 receiving module and present at the input of the port C of the XATM switch is routed by the XATM switch toward the output of the port H and consequently toward the processing module F-AAL2 to undergo there the said anticipated processing. The ATM cells transmitted at the output of this F-AAL2 module are routed from the input of the port H toward the output of the port D of the XATM switch and hence toward the input of the out-AAL2 transmitting module.

In the event the switching unit contains several processing units such as the F-AAL2 unit, the intermediate cells ATM transmitted by the in-AAL2 receiving modules then would be routed toward one or the other of these processing units depending on criteria illustratively linked to the features of said ATM cells (being part of a particular virtual circuit VCI) or on the features of the packets they contain (CID etc.).

Be it borne in mind that the routing within the XATM switch may be designed in a manner that the AAL2 packets shall be shielded from the processing carried out by the F-AAL2 module(s). In such a case, the intermediate cell delivered by the in-AAL2 receiving module and present at the input of the port C of the XATM switch shall be directly routed by the XATM switch toward the output of the port D of the switch XATM and consequently toward the input of the out-AAL2 transmitting module.

The switching procedures which must be carried out are described in the TRANM table (which for legibility in FIG. 5 is omitted) that is associated with the XATM switch. Said table shall distinguish between the virtual circuits VC transporting the packets which must be switched and the virtual circuits VC transporting packets to be processed in the F-AAL2 module, further the virtual circuits VC transporting signaling messages toward AAL5, the VC virtual circuits to be mixed, etc.

Next and in illustrative manner, a switching unit such as is shown in FIG. 4 shall be considered that therefore contains only one in-AAL2 receiving termination module and only one out-AAL2 module. Moreover each of said modules is fitted with a single input and a single output.

It is noted that a permanent connection is set up in the XATM switch between the in-AAL2 receiving module and the out-AAL2 transmitting module. This connection must be transparent to all VC circuits that may support AAL2 connections. The in-AAL2 receiving module is transparent to the connection identifier CID of the AAL2 packets. It implements the standard retrieval operations and simplified insertion operation (no STF octet and only one AAL2 packet per cell). As regards the out-AAL2 transmitting module, it implements the operations of translating identifiers of virtual circuits VPI/VCI and of connection identifiers CID. Said latter module moreover carries out standard insertions and simplified retrieval. It does not route.

The table below illustrates an illustrative connection assignment to the ports of the switching unit and of the XATM switch.

| Switching | | |
|---|---|---|
| unit port | XATM switch port | Connection |
| 1 | A | C × 1, C × 2, C × 3, C × 4 |
| 2 | B | C × 5, C × 6 |
| 3 | E | C × 1, C × 4, C × 5 |
| 4 | F | C × 3, C × 6 |
| 5 | G | C × 2 |

Illustrative programming of the translation table of the XATM switch is shown below.

| Inputs | | | Outputs | | |
|---|---|---|---|---|---|
| Port | VPI | VCI | Port | VPI | VCI |
| A | 0 | 100 | C | 0 | 100 |
| A | 0 | 110 | C | 0 | 101 |
| B | 0 | 100 | C | 0 | 102 |
| E | 0 | 100 | C | 0 | 200 |
| F | 0 | 150 | C | 0 | 201 |
| G | 0 | 200 | C | 0 | 202 |
| D | 0 | 100 | E | 0 | 100 |
| D | 0 | 101 | F | 0 | 150 |
| D | 0 | 102 | G | 0 | 200 |
| D | 0 | 200 | A | 0 | 100 |
| D | 0 | 201 | A | 0 | 110 |
| D | 0 | 202 | B | 0 | 100 |
| C | 0 | 0 to 255 | D | 0 | 0 to 255 |

The programming of the translation table of the out-AAL2 transmitting module is shown below. Each row corresponds to one AAL2 connection. Once again the duplicate representation of each connection arises from the module being used in the two directions of the connection.

| | |
|---|---|
| Inputs | Outputs |

| | VCI | CID | VCI | CID |
|---|---|---|---|---|
| C × 1 | 100 | 10 | 100 | 15 |
| C × 2 | 100 | 20 | 102 | 30 |
| C × 3 | 101 | 10 | 101 | 10 |
| C × 4 | 101 | 30 | 100 | 20 |
| C × 5 | 102 | 15 | 100 | 30 |
| C × 6 | 102 | 20 | 101 | 25 |
| C × 1 | 200 | 15 | 200 | 10 |
| C × 2 | 202 | 30 | 200 | 20 |
| C × 3 | 201 | 30 | 201 | 10 |
| C × 4 | 200 | 20 | 201 | 30 |
| C × 5 | 200 | 10 | 202 | 15 |
| C × 6 | 201 | 25 | 202 | 20 |

The connection cx4 in the direction from A to E is illustratively described below.

On the multiplexer A: VC 110, CID 30 (cx4 shares the VC 110 with cx3)

On the link a): VC 110 was translated into VC 101,

On the links b) and c): the CID 30 packets are alone in VC 101,

On the link d): CID 30 is translated into CID 20, VC 101 is translated into 100,

On the multiplexer E: VC 100, CD 20 (Cx4 shares VC 100 with cx1 and cx5).

In the direction from E to A, the results would be:

On the multiplexer E: VC 100, CID 20 (cxv shares VC 100 with cx1 and cx5).

On the link a: VC 100 was translated into VC 200,

On the links b and c: the packets are alone in VC 200,

On the link d: CID 20 is translated into CID 30, VC 200 is translated into 201,

On the multiplexer A: VC 110, CID 30 (cx4 shares the VC with cx3).

Overall switching may be visualized by the table below:

| | |
|---|---|
| Inputs or Outputs | Outputs or Inputs |

| | Port | VPI | VCI | CID | Port | VPI | VCI | CID |
|---|---|---|---|---|---|---|---|---|
| C × 1 | A | 0 | 100 | 10 | E | 0 | 100 | 15 |
| C × 2 | A | 0 | 100 | 20 | G | 0 | 200 | 30 |
| C × 3 | A | 0 | 110 | 10 | F | 0 | 150 | 10 |
| C × 4 | A | 0 | 110 | 30 | E | 0 | 100 | 20 |
| C × 5 | B | 0 | 100 | 15 | E | 0 | 100 | 30 |
| C × 6 | B | 0 | 100 | 20 | F | 0 | 150 | 25 |

The above described embodiments of a switching unit only made use of in-AAL2 and out-AAL2 receiving and transmitting modules respectively that were fitted with a single input and a single output. Nevertheless, in order to increase the traffic capacity when the equipment comprises many multiplexers of which the AAL2 traffic loads are high, they may advantageously be fitted with several inputs and outputs. The same applies as needed when separating the kinds of traffic as a function of several criteria (illustratively, real time or not, rising or descending directions, particular processing applied to packets such as switching or termination, or a combination of such criteria).

Again, in order to improve equipment performance, several in-AAL2 and out-AAL2 receiving and transmitting modules respectively may be used which are also placed as servers. The results so attained are wholly similar to those discussed the immediately preceding paragraph. Reliability is added to the extent the equipment may be less vulnerable to malfunctioning AAL2 modules.

FIG. 6 shows a switching unit considered solely in terms of signaling. Besides the XATM switch and the in-AAL2 and out-AAL2 receiving and transmitting modules respectively, said switching unit also includes a signaling unit S-AAL2 for processing the AAL2 control operations as standardized by ITU Recommendation I2630. This S-AAL2 signaling until is interfaced on one hand with the in-AAL2 receiving termination modules and the out-AAL2 transmitting termination modules, and, on the other hand, with the TRANM translation memory of the XATM switch. This S-AAL2 signaling unit allows updating the translation tables TRANM, Min-AAL2 and Mout-AAL2 respectively present in the XATM switch and in the in-AAL2 and out-AAL2 termination modules. As shown in FIG. 6, the virtual signaling links relating to AAL2 connections from the input multiplexers all are routed toward the S-AAL2 signaling unit. The output signals from latter unit move along the reverse paths.

Call by call management of the ATM connections is carried out in the XATM switch by means of a control operation processing the standardized signaling protocol. The permanent connections also are set up conventionally by the network administrator. Again the translation table of the ATM switch must be updated every time the AAL2 connections are set up or released.

Beyond the advantages already discussed above, the present invention also offers other advantages linked to an architecture that includes servers. The servers are set up and made operational depending on the needs of AAL2 traffic. Such equipment use may be progressive. The equipment of the invention assures simultaneously AAL2 termination functions and AAL2 switching functions. Performance is improved by the presence of modules, some dedicated to AAL2 receiving operation, the others to AAL2 transmitting operations.

1. A switching unit for a packet transmitting network, to switch a connection's packets present at an input of said connection's ports toward at least one desired output of its ports, said packets, denoted as “upper layer packets”, being transported by lower-layer packets, said switching unit comprising:
at least one receiving termination module for retrieving, from the lower layer packets present at its input, the upper layer packets contained in said lower packets and for inserting each upper layer packet retrieved in this manner into a unique lower layer packet, denoted “intermediate packet”, and for delivering said intermediate packet,
at least one transmitting termination module for retrieving said upper layer packet from said intermediate packet and for inserting it optionally together with other packets into one or several lower layer packets and for delivering said lower layer packets,
a switch for routing said lower layer packets present at one of its inputs toward one of its output ports, said switch output port being connected to an input of a receiving termination module for routing the intermediate packets transmitted by said or each receiving termination module toward an output port of the particular receiving termination module, said output port of the particular receiving termination module being connected to an input of a transmitting termination module, for routing the packets transmitted from the lower layer through said or each transmitting termination module toward the desired port of said unit.

2. Switching unit as claimed in claim 1, further comprising a module for carrying out special processing of the upper layer packets, said processing module being arranged to receive the intermediate packets transmitted from the receiving termination module for processing the upper layer packets included in said intermediate packets and for re-transmitting said intermediate packets so said upper layer packets so processed are inserted into the intermediate packets.

3. Switching unit as claimed in claim 2, wherein said switch is arranged for routing said lower layer packets present at one of its inputs toward one of its output ports, said output port of the switch being connected to the input of a receiving termination module for routing the intermediate packets transmitted from the or each receiving termination module toward an output port, said latter port being connected to the input of said processing unit for routing the intermediate packets retransmitted from said processing unit toward the output of one of its ports, said latter output port being connected to the input of a transmitting termination module, and for routing the lower layer packets transmitted from said or each transmitting termination module toward the desired output port of said unit.

4. Switching unit as claimed in claim 1 wherein said switch is assigned for routing the lower level packets that may not contain upper layer packets directly toward the desired output port of said switching unit.

5. Switching unit as claimed in claim 1, wherein said upper layer packets include a header including a connection identifier, said or each receiving termination module being arranged for carrying out the connection identifier translations required for switching.

6. Switching unit as claimed in claim 1 wherein said upper layer packets include a header including a connection identifier, said or each transmitting termination module being arranged for carrying out the connection identifier translations required for switching.

7. Switching unit as claimed in claim 1, wherein said lower layer packets include a header including a circuit identifier, said or each receiving or transmitting termination model being arranged for carrying out the connection identifier translations required for switching.

8. Switching unit as claimed in claim 1, further including a signaling unit for (a) processing the signaling packet that corresponds to the protocol of the upper layer packets and (b) controlling identifier-translation memories contained in said switch, in said receiving termination module and/or in said transmitting termination module.

9. Switching unit as claimed in claim 8, wherein said switch is arranged for routing said signaling packets present at one of its inputs toward one of its output ports, said last named output port being connected to the input of said signaling unit for routing the signaling packets delivered by said signaling unit toward the desired output port of said unit.

10. Switching unit as claimed in claim 1, further comprising plural receiving termination models and plural transmitting termination modules, said models being dedicated to particular connections and to particular virtual circuits.

11. Switching unit as claimed in claim 10, further comprising at least one pair of receiving termination modules and at least one pair of transmitting termination modules, each module of each pair being allocated to a particular ascending or descending direction of the connections.

12. Switching unit as claimed in claim 1, wherein the lower layer packets are ATM cells.

13. Switching unit as claimed in claim 1, wherein the upper layer packets are AAL2 packets.

14. Switching unit as claimed in claim 1, further comprising plural receiving termination models and plural transmitting termination modules, said models being dedicated to particular connections or to particular virtual circuits.
